(19) United States
(12) Patent Application Publication
(10) Pub. No.: US 2018/0029075 A1
(43) Pub. Date: Feb. 1, 2018

(54) Vibrating Sorting Table

(71) Applicant: Raul Martinez, Milton, GA (US)

(72) Inventor: Raul Martinez, Milton, GA (US)

(21) Appl. No.: 15/225,348

(22) Filed: Aug. 1, 2016

(51) Int. Cl. B06B 1/02; B23P 19/04

(52) U.S. Cl. CPC B06B 1/02; B23P 19/04

(57) ABSTRACT

A vibrating sorting table for separating loosely attached parts from a workpiece includes a bench. The bench comprises a bottom. Each of a plurality of supports is coupled to and extends substantially vertically from a respective edge of the bottom. A top is flexibly coupled to each of the supports. The top is substantially parallel to the bottom. The top is movable relative to the supports and the bottom. A pair of rims is coupled singly to opposing sides of the top. The rims separate a workpiece positioned on the bench from an upper face of the top. A vibration unit is coupled to a lower face of the top. The vibration unit is positioned to impart vibrational forces to the top, such that the workpiece coupled to the top vibrates. Parts of the workpiece that are loosely attached separate from the workpiece and fall to the upper face of the top.

### BACKGROUND OF THE DISCLOSURE

### Field of the Disclosure

The disclosure relates to sorting tables and more particularly pertains to a new sorting table for separating loosely attached parts from a workpiece.

### SUMMARY OF THE DISCLOSURE

An embodiment of the disclosure meets the needs presented above by generally comprising a bench. The bench comprises a bottom. Each of a plurality of supports is coupled to and extends substantially vertically from a respective edge of the bottom. A top is flexibly coupled to each of the supports. The top is substantially parallel to the bottom. The top is movable relative to the supports and the bottom. A pair of rims is coupled singly to opposing sides of the top. The rims separate a workpiece positioned on the bench from an upper face of the top. A vibration unit is coupled to a lower face of the top. The vibration unit is positioned to impart vibrational forces to the top, such that the workpiece coupled to the top vibrates. Parts of the workpiece that are loosely attached separate from the workpiece and fall to the upper face of the top.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a vibrating sorting table according to an embodiment of the disclosure.

FIG. 2 is an isometric perspective view of an embodiment of the disclosure.

FIG. 3 is a front view of an embodiment of the disclosure.

FIG. 4 is an isometric perspective view of an embodiment of the disclosure.

FIG. 5 is a top cut-away view of an embodiment of the disclosure.

### DESCRIPTION OF THE PREFERRED EMBODIMENT

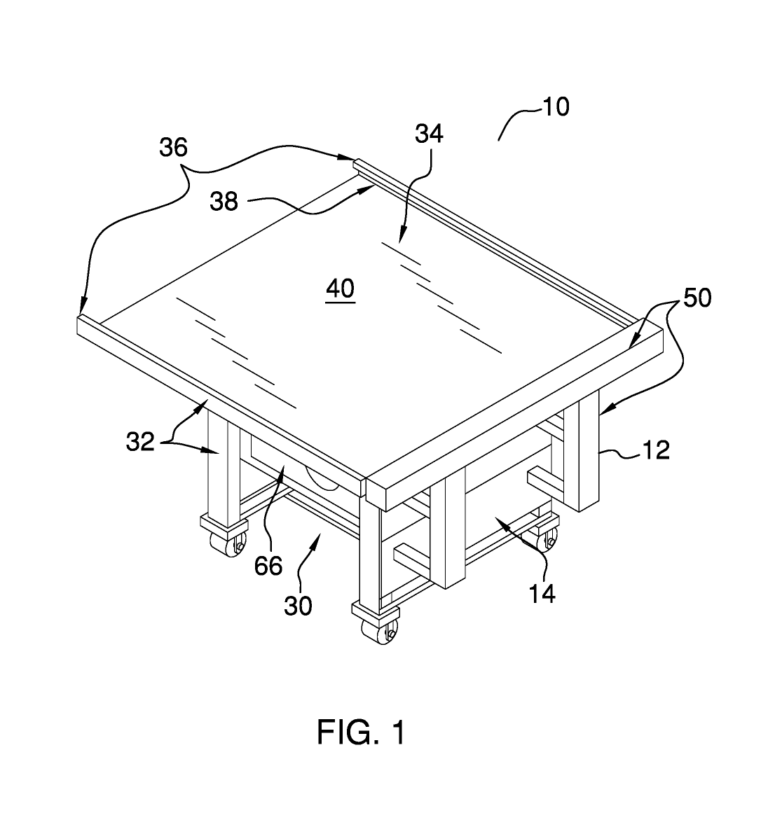

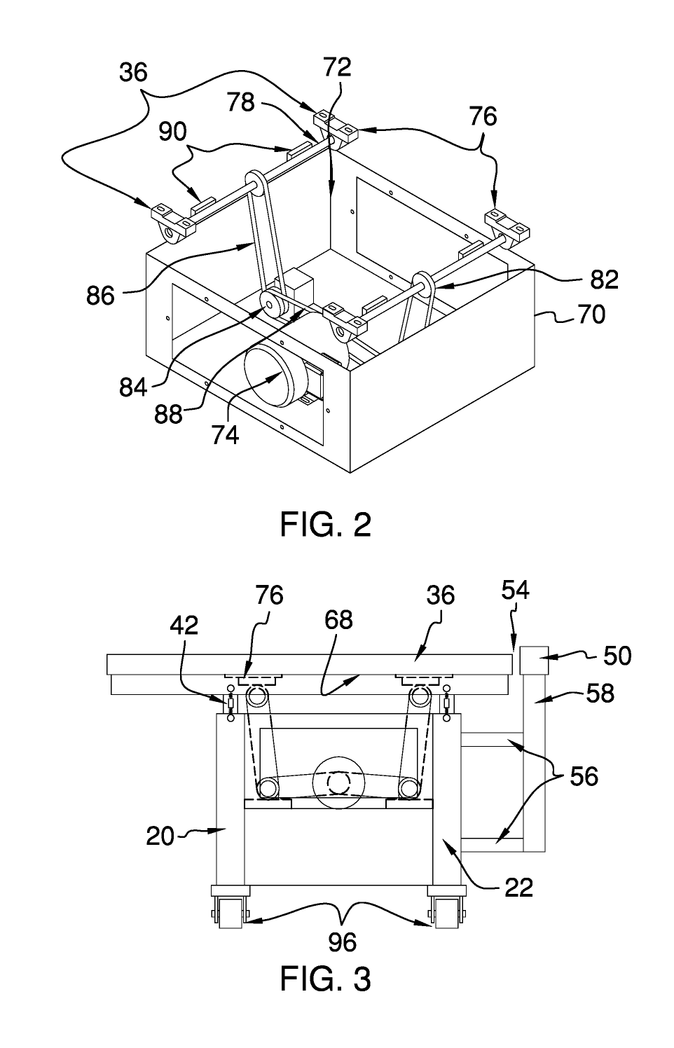

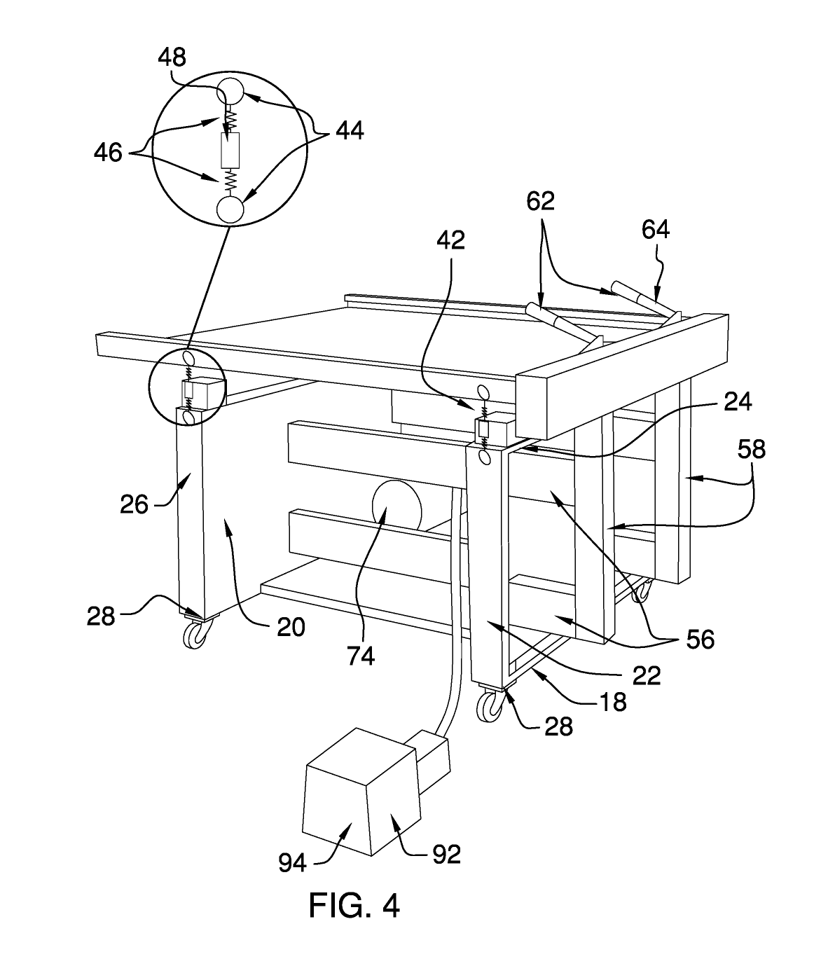

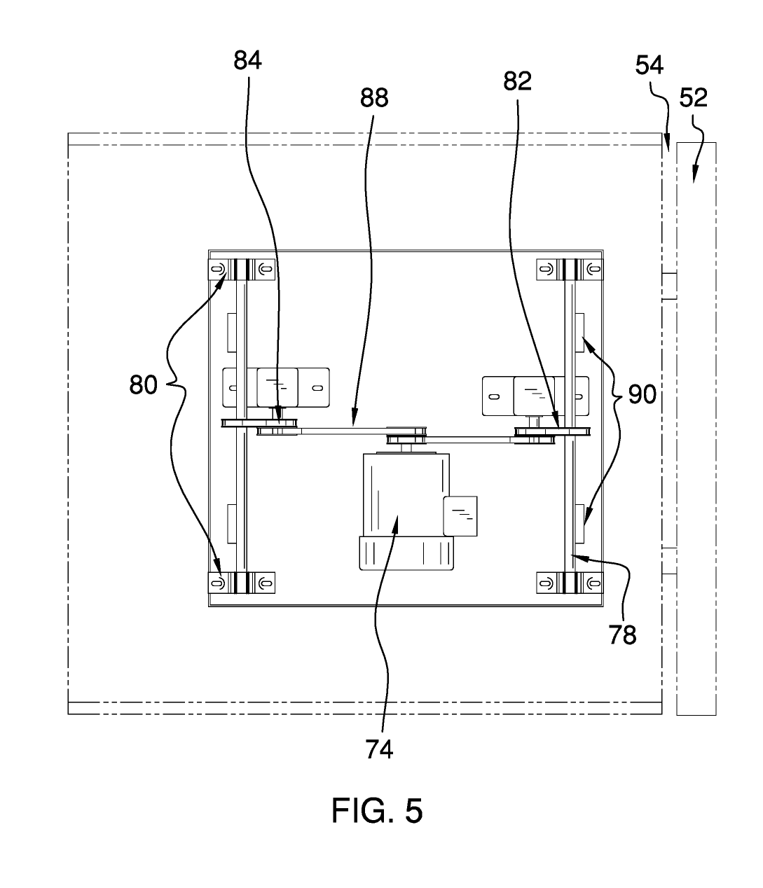

With reference now to the drawings, and in particular to FIGS. 1 through 5 thereof, a new sorting table embodying the principles and concepts of an embodiment of the disclosure and generally designated by the reference numeral 10 will be described.

As best illustrated in FIGS. 1 through 5, the vibrating sorting table 10 generally comprises a bench 12. The bench 12 comprises a bottom 14 that is substantially rectangularly shaped.

Each of a plurality of supports 16 is coupled to and extends substantially vertically from a respective edge 18 of the bottom 14. In one embodiment, the plurality of supports 16 comprises a wall 20 and a pair of posts 22 that are coupled to and extend substantially vertically from respective edges 18 of the bottom 14. A crossbar 24 is coupled to and extends between the posts 22 distal from the bottom 14. The posts 22 and opposing ends 26 of the wall 20 are positioned such that the posts 22 and the opposing ends 26 of the wall 20 define corners 28 of the bottom 14.

A recess 30 is positioned in the bottom 14. The recess 30 extends between a respective opposing end 26 of the wall 20 and a respective post 22, thus defining a front 32 of the bench 12. The recess 30 is positioned in the bottom 14 such that the recess 30 is configured to allow a user to stand proximate to the front 32 of the bench 12.

A top 34 is flexibly coupled to each of the supports 16. The top 34 is substantially parallel to the bottom 14. The top 34 is positioned on the supports 16 such that the top 34 is movable relative to the supports 16 and the bottom 14.

A pair of rims 36 is coupled singly to opposing sides 38 of the top 34. The rims 36 are positioned on the top 34 such that a workpiece positioned on the bench 12 is separated from an upper face 40 of the top 34 by the rims 36.

A plurality of fasteners 42 is coupled to and extends between the plurality of supports 16 and the top 34. The fasteners 42 are flexible. In one embodiment, each fastener 42 comprises a pair of bushings 44, a pair of springs 46 and a bolt 48. The pair of bushings 44 is coupled singly to the top 34 and the bottom 14. The pair of springs 46 is coupled singly to the bushings 44. The bolt 48 is coupled to and extends between the springs 46.

A positioner 50 is coupled to and extends from the bench 12. A horizontal member 52 of the positioner 50 is positioned substantially coplanarly with the rims 36. The horizontal member 52 extends substantially between the rims 36 proximate to the top 34, such that the horizontal member 52 and the top 34 define a gap 54. In one embodiment, the positioner 50 comprises a plurality of braces 56 that is coupled to and extends substantially horizontally from the bench 12. A pair of vertical members 58 is coupled to respective braces 56 distal from the bench 12. The vertical members 58 are positioned substantially parallel to the supports 16. The horizontal member 52 is coupled to upper ends 60 of the vertical members 58. In another embodiment, the plurality of braces 56 comprises two braces 56 that are coupled to the bottom 14 and two braces 56 that are coupled to the crossbar 24.

A plurality of couplers 62 is coupled to the horizontal member 52. The couplers 62 are configured to couple to the workpiece. The couplers 62 are positioned on the horizontal member 52 such that the couplers 62 are configured to retain the workpiece on the rims 36. In one embodiment, the couplers 62 comprise clamps 64. In another embodiment, the plurality of couplers 62 comprises two couplers 62.

A vibration unit 66 is coupled to a lower face 68 of the top 34. The vibration unit 66 is positioned on the top 34 and is positioned to impart vibrational forces to the top 34. The workpiece that is coupled to the top 34 vibrates, such that loosely attached parts of the workpiece separate from the workpiece and fall to the upper face 40 of the top 34. In one embodiment, the vibration unit 66 comprises a housing 70. The housing 70 is substantially rectangularly box shaped. The housing 70 has an open face 72 positioned proximate to the lower face 68 of the top 34.

A plurality of motors 74 is coupled to and positioned in the housing 70. In one embodiment, the motors 74 are electric. In another embodiment, the plurality of motors 74 comprises one motor 74.

A plurality of connectors 76 is coupled to and extends from the lower face 68 of the top 34. In one embodiment, the plurality of connectors 76 comprises four connectors 76.

Each of a plurality of axles 78 is rotationally coupled to and extends between a respective pair of the connectors 80. Each of a plurality of first pulleys 82 is fixedly coupled to a respective axle 78. Each first pulley 82 is operationally coupled to a respective motor 74. In one embodiment, a plurality of second pulleys 84 is rotationally coupled to and positioned in the first housing 70. Each of a plurality of first belts 86 is operationally coupled to a respective first pulley 82 and a respective second pulley 84. Each of a plurality of second belts 88 is operationally coupled to a respective second pulley 84 and a respective motor 74.

A plurality of counterweights 90 is coupled to the axles 78. The counterweights 90 are positioned on the axles 78 such that the axles 78 are unbalanced. Rotation of the axles 78 induces vibration of the top 34.

A controller 92 is operationally coupled to the plurality of motors 74. The controller 92 is configured to turn the motors 74 on and off. In one embodiment, the controller 92 comprises a foot pedal 94.

In another embodiment, a plurality of wheels 96 is rotationally coupled to the bottom 14. The wheels 96 are positioned on the bench 12 such that the wheels 96 are configured for a user to roll the bench 12 on a surface. In yet another embodiment, the plurality of wheels 96 comprises wheels 96 positioned proximate to the corners 28 of the bottom 14.

In one embodiment of the invention, the pair of posts 22 is dimensionally longer that the wall 20, such that the top 34 is tilted relative to the bottom 14. Parts of the workpiece that fall to the upper face 40 of the top 34 are vibrationally motivated to fall from the top 34 over the wall 20.

In use, the couplers 62 are configured to retain the workpiece on the rims 36. The rims 36 are positioned on the top 34 such that a workpiece positioned on the bench 12 is separated from an upper face 40 of the top 34 by the rims 36. The counterweights 90 are positioned on the axles 78 such that the axles 78 are unbalanced. Rotation of the axles 78 induces vibration of the top 34, such that the workpiece that is coupled to the top 34 vibrates. Parts that are loosely attached to the workpiece separate from the workpiece and fall to the upper face 40 of the top 34. The parts of the workpiece that fall to the upper face 40 of the top 34 are vibrationally motivated to fall from the top 34 over the wall 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vibrating sorting table comprising:
a bench comprising:
a bottom;
a plurality of supports, each said support being coupled to and extending substantially vertically from a respective edge of said bottom,
a top flexibly coupled to each of said supports, such that said top is substantially parallel to said bottom, wherein said top is positioned on said supports such that said top is movable relative to said supports and said bottom, and
a pair of rims coupled singly to opposing sides of said top, wherein said rims are positioned on said top such that a workpiece positioned on said bench is separated from an upper face of said top by said rims;
a vibration unit coupled to a lower face of said top; and
wherein said vibration unit is positioned on said top such that said vibration unit is positioned to impart vibrational forces to said top, such that the workpiece coupled to said top vibrates and wherein loosely attached parts of the workpiece separate from the workpiece and fall to said upper face of said top.

2. The table of claim 1, further including said bottom being substantially rectangularly shaped.

3. The table of claim 1, further including said plurality of supports comprising:
a wall coupled to and extending substantially vertically from a respective edge of said bottom;
a pair of posts coupled to and extending substantially vertically from a respective edge of said bottom; and
wherein said posts and opposing ends of said wall are positioned such that said posts and said opposing ends of said wall define corners of said bottom.

4. The table of claim 3, further including said pair of posts being dimensionally longer that said wall, such that said top is tilted relative to said bottom, wherein parts of the workpiece that fall to said upper face of said top are vibrationally motivated to fall from said top over said wall.

5. The table of claim 3, further including a recess positioned in said bottom, said recess extending between a respective opposing end of said wall and a respective said post defining a front of said bench, wherein said recess is positioned in said bottom such that said recess is configured to allow a user to stand proximate to said front of said bench.

6. The table of claim 1, further including a plurality of fasteners coupled to and extending between said plurality of supports and said top, said fasteners being flexible.

7. The table of claim 6, further including each said fastener comprising:
a pair of bushings coupled singly to said top and said bottom;
a pair of springs coupled singly to said bushings; and
a bolt coupled to and extending between said springs.

8. The table of claim 3, further including a positioner coupled to and extending from said bench, such that a horizontal member of said positioner is positioned substantially coplanarly with said rims, said horizontal member extending substantially between said rims proximate to said top, such that said horizontal member and said top define a gap.

9. The table of claim 8, further comprising:
a crossbar coupled to and extending between said posts distal from said bottom; and
said positioner comprising:
a plurality of braces coupled to and extending substantially horizontally from said bench, said plurality of braces comprising two said braces coupled to said bottom and two said braces coupled to said crossbar,
a pair of vertical members coupled to respective said braces distal from said bench, such that said vertical members are positioned substantially parallel to said supports, and
said horizontal member being coupled to upper ends of said vertical members.

10. The table of claim 9, further including a plurality of couplers coupled to said horizontal member, said couplers being configured to couple to the workpiece, wherein said couplers are positioned on said horizontal member such that said couplers are configured to retain the workpiece on said rims.

11. The table of claim 10, further including said couplers comprising clamps.

12. The table of claim 10, further including said plurality of couplers comprising two said couplers.

13. The table of claim 1, further including said vibration unit comprising:
a housing, said housing being substantially rectangularly box shaped, said housing having an open face positioned proximate to said lower face of said top;
a plurality of motors coupled to and positioned in said housing, said motors being electric;
a plurality of connectors coupled to and extending from said lower face of said top;
a plurality of axles, each said axle being rotationally coupled to and extending between a respective pair of said connectors;
a plurality of first pulleys, each said first pulley being fixedly coupled to a respective said axle, each said first pulley being operationally coupled to a respective said motor;
a plurality of counterweights coupled to said axles, wherein said counterweights are positioned on said axles such that said axles are unbalanced, and
wherein rotation of said axles induces vibration of said top.

14. The table of claim 13, further comprising:
said plurality of motors comprising one said motor; and
said plurality of connectors comprising four said connectors.

15. The table of claim 13, further including said vibration unit comprising:
a plurality of second pulleys rotationally coupled to and positioned in said first housing;
a plurality of first belts, each said first belt being operationally coupled to a respective said first pulley and a respective said second pulley; and
a plurality of second belts, each said second belt being operationally coupled to a respective said second pulley and a respective said motor.

16. The table of claim 1, further including a controller operationally coupled to said plurality of motors, said controller being configured to turn said motors on and off.

17. The table of claim 16, further including said controller comprising a foot pedal.

18. The table of claim 1, further including a plurality of wheels rotationally coupled to said bottom, wherein said wheels are positioned on said bench such that said wheels are configured for a user to roll said bench on a surface.

19. The table of claim 18, further including said plurality of wheels comprising wheels positioned proximate to said corners of said bottom.

20. A vibrating sorting table comprising:
a bench comprising:
a bottom, said bottom being substantially rectangularly shaped,
a plurality of supports, each said support being coupled to and extending substantially vertically from a respective edge of said bottom, said plurality of supports comprising:
a wall coupled to and extending substantially vertically from a respective edge of said bottom,
a pair of posts coupled to and extending substantially vertically from a respective edge of said bottom, and
wherein said posts and opposing ends of said wall are positioned such that said posts and said opposing ends of said wall define corners of said bottom,
a recess positioned in said bottom, said recess extending between a respective opposing end of said wall and a respective said post defining a front of said bench, wherein said recess is positioned in said bottom such that said recess is configured to allow a user to stand proximate to said front of said bench,
a crossbar coupled to and extending between said posts distal from said bottom,
a top flexibly coupled to each of said supports, such that said top is substantially parallel to said bottom, wherein said top is positioned on said supports such that said top is movable relative to said supports and said bottom, and
a pair of rims coupled singly to opposing sides of said top, wherein said rims are positioned on said top such that a workpiece positioned on said bench is separated from an upper face of said top by said rims;
a plurality of fasteners coupled to and extending between said plurality of supports and said top, said fasteners being flexible, each said fastener comprising:
a pair of bushings coupled singly to said top and said bottom,
a pair of springs coupled singly to said bushings, and
a bolt coupled to and extending between said springs;
a positioner coupled to and extending from said bench, such that a horizontal member of said positioner is positioned substantially coplanarly with said rims, said horizontal member extending substantially between said rims proximate to said top, such that said horizontal member and said top define a gap, said positioner comprising:
a plurality of braces coupled to and extending substantially horizontally from said bench, said plurality of braces comprising two said braces coupled to said bottom and two said braces coupled to said crossbar, a pair of vertical members coupled to respective said braces distal from said bench, such that said vertical members are positioned substantially parallel to said supports, and
said horizontal member being coupled to upper ends of said vertical members;
a plurality of couplers coupled to said horizontal member, said couplers being configured to couple to the workpiece, wherein said couplers are positioned on said horizontal member such that said couplers are configured to retain the workpiece on said rims, said couplers comprising clamps, said plurality of couplers comprising two said couplers;
a vibration unit coupled to a lower face of said top, wherein said vibration unit is positioned on said top such that said vibration unit is positioned to impart vibrational forces to said top, such that the workpiece coupled to said top vibrates and wherein loosely attached parts of the workpiece separate from the workpiece and fall to said upper face of said top, said vibration unit comprising:
a housing, said housing being substantially rectangularly box shaped, said housing having an open face positioned proximate to said lower face of said top,
a plurality of motors coupled to and positioned in said housing, said motors being electric, said plurality of motors comprising one said motor,
a plurality of connectors coupled to and extending from said lower face of said top, said plurality of connectors comprising four said connectors,
a plurality of axles, each said axle being rotationally coupled to and extending between a respective pair of said connectors,
a plurality of first pulleys, each said first pulley being fixedly coupled to a respective said axle, each said first pulley being operationally coupled to a respective said motor,
a plurality of second pulleys rotationally coupled to and positioned in said first housing,
a plurality of first belts, each said first belt being operationally coupled to a respective said first pulley and a respective said second pulley,
a plurality of second belts, each said second belt being operationally coupled to a respective said second pulley and a respective said motor,
a plurality of counterweights coupled to said axles, and
wherein said counterweights are positioned on said axles such that said axles are unbalanced, such that rotation of said axles induces vibration of said top;
a controller operationally coupled to said plurality of motors, said controller being configured to turn said motors on and off, said controller comprising a foot pedal;
a plurality of wheels rotationally coupled to said bottom, wherein said wheels are positioned on said bench such that said wheels are configured for a user to roll said bench on a surface, said plurality of wheels comprising wheels positioned proximate to said corners of said bottom;
said pair of posts being dimensionally longer that said wall, such that said top is tilted relative to said bottom, wherein parts of the workpiece that fall to said upper face of said top are vibrationally motivated to fall from said top over said wall; and
wherein said couplers are positioned on said horizontal member such that said couplers are configured to retain the workpiece on said rims, wherein said rims are positioned on said top such that a workpiece positioned on said bench is separated from an upper face of said top by said rims, wherein said counterweights are positioned on said axles such that said axles are unbalanced, such that rotation of said axles induces vibration of said top, such that the workpiece coupled to said top vibrates and wherein loosely attached parts of the workpiece separate from the workpiece and fall to said upper face of said top, wherein parts of the workpiece that fall to said upper face of said top are vibrationally motivated to fall from said top over said wall.
